(19) United States
(12) Patent Application Publication
(10) Pub. No.: US 2011/0221637 A1
(43) Pub. Date: Sep. 15, 2011

(54) MONOPOLE ANTENNA

(75) Inventor: HSIN-LUNG TU, Tu-Cheng (TW)

(73) Assignee: HON HAI PRECISION INDUSTRY CO., LTD., Tu-Cheng (TW)

(21) Appl. No.: 12/848,214

(22) Filed: Aug. 1, 2010

(30) Foreign Application Priority Data
Mar. 12, 2010 (CN) 201020130009.1

(51) Int. Cl. H01Q 1/38

(52) U.S. Cl. 343/700 MS

(57) ABSTRACT

A monopole antenna is disposed on a substrate. The substrate includes a first surface and a second surface opposite to the first surface. The monopole antenna includes a feeding portion, a radiating portion, a grounding portion and a coupling portion. The feeding portion is disposed on the first surface to feed electromagnetic signals. The radiating portion is disposed on the first surface and with one end connected to the feeding portion. The grounding portion is positioned on the second surface substantially corresponding to the one end of the radiating portion. The coupling portion is positioned on the second surface and corresponding to the other end of the radiating portion. The radiating portion is coupled with the coupling portion to radiate electromagnetic signals.

### BACKGROUND

1. Technical Field

The present disclosure relates to an antenna, and more particularly to a monopole antenna.

2. Description of Related Art

Antennas are important components of wireless communication devices. The antennas affect communication reception of the wireless communications devices. Monopole antennas are gaining popularity, due to easy production and good performance. However, one disadvantage of monopole antennas is that when monopole antennas are miniaturized, the monopole antennas suffer from a narrow grounding area, bad radiating effect, and small gains.

Therefore, a need exists in the industry to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of a monopole antenna according to the present disclosure.

FIG. 2 is a schematic diagram showing an exemplary radiating portion of the monopole antenna of FIG. 1.

FIG. 3 is a schematic diagram showing a grounding portion and a coupling portion of the monopole antenna according to a first preferred embodiment of the present disclosure.

FIG. 4 is a schematic diagram showing the grounding portion and the coupling portion of the monopole antenna according to a second preferred embodiment of the present disclosure.

FIG. 5 is a graph showing an exemplary return loss of the monopole antenna of FIG. 3.

FIG. 6 is a graph showing an exemplary gain of the monopole antenna of FIG. 3.

FIG. 7 is a graph showing an exemplary return loss of the monopole antenna of FIG. 4.

FIG. 8 is a graph showing an exemplary gain of the monopole antenna of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

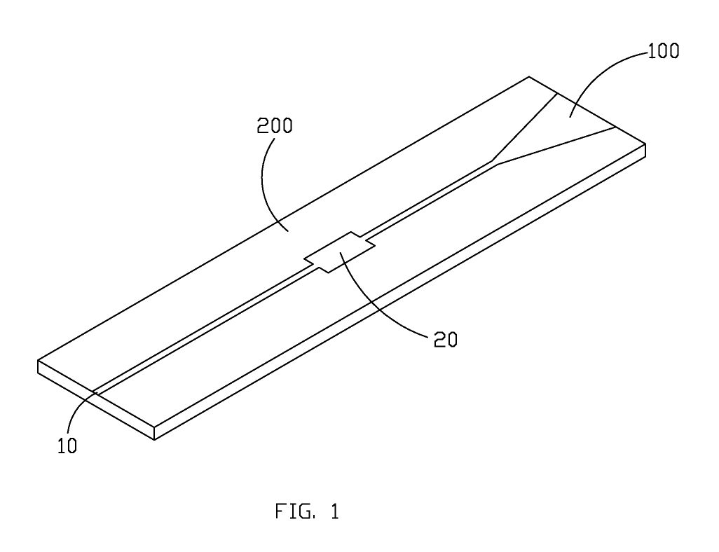

Referring to FIG. 1 to FIG. 3, a monopole antenna 100 is disposed on a substrate 200. The substrate 200 comprises a first surface 201 and a second surface 202 opposite to the first surface 201. The monopole antenna 100 comprises a feeding portion 10, a radiating portion 20, a grounding portion 40 and a coupling portion 60. The feeding portion 10 is disposed on the first surface 201 to feed electromagnetic signals. The radiating portion 20 is disposed on the first surface 201 and with one end connected to the feeding portion 10. The grounding portion 40 is positioned on the second surface 202 substantially corresponding to the one end of the radiating portion. The coupling portion 60 is disposed on the second surface 202 and corresponding to the other end of the radiating portion 20. The radiating portion 20 is coupled with the coupling portion 60 to radiate electromagnetic signals.

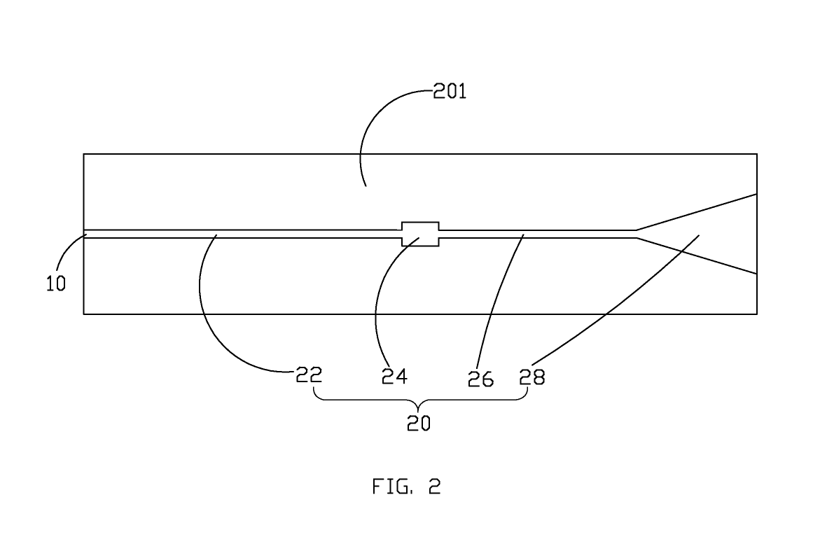

Referring to FIG. 2, the radiating portion 20 comprises a first radiator 22, a second radiator 24, a third radiator 26 and a fourth radiator 28, which are connected one by one. One end of the first radiator 22 is connected with the feeding portion 10. The second radiator 24 is disposed at a center of the radiating portion 20 and connected between the first radiator 22 and the third radiator 26. The third radiator 26 is disposed between the second radiator 24 and the fourth radiator 28. The first radiator 22 and the third radiator 26 are configured as slender microstrips with a same width. The second radiator 24 is configured as a rectangular microstrip. However, the second radiator 24 is wider than the first radiator 22 and the third radiator 26. The fourth radiator 28 extends from one end of the third radiator 26 and shaped as a triangular metal layer. In the illustrated embodiment, the first radiator 22, the second radiator 24, the third radiator 26 and the fourth radiator 28 are collinear and symmetrical.

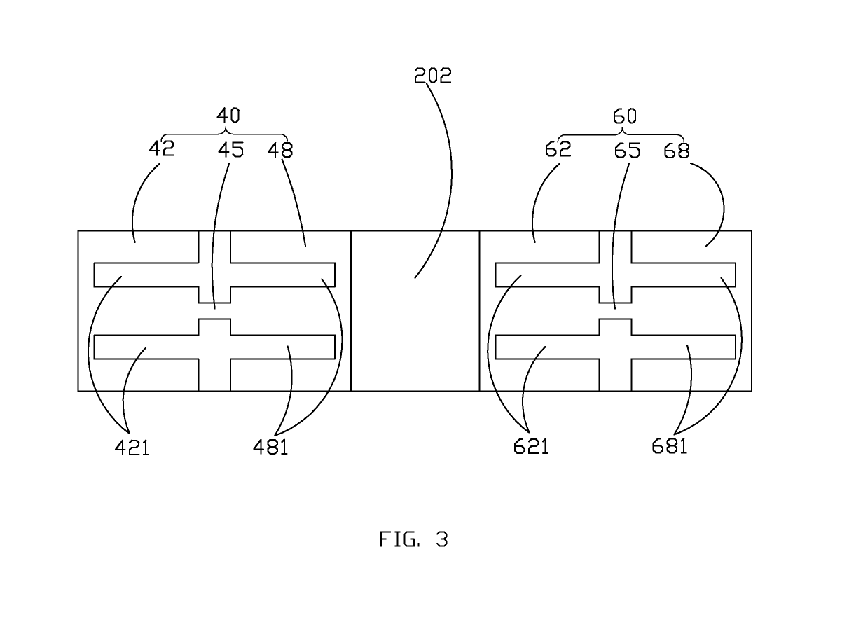

Referring to FIG. 3, the grounding portion 40 corresponds to the first radiator 22 and comprises a first grounding area 42, a second grounding area 48 and a grounding connector 45 communicationally connecting the first grounding area 42 with the second grounding area 48. The first grounding area 42 defines a pair of first grounding slots 421 and the second grounding area 48 defines a pair of second grounding slots 481. The pair of first grounding slots 421 are parallel to each other so that the first grounding area 42 is in an E-shape. Similarly, the pair of second grounding slots 481 are parallel to each other so that the second grounding area 48 is in an E-shape which is reverse to that of the first grounding area 42. In the illustrated embodiment, each of the pair of first grounding slots 421 is collinear with and communicates with a corresponding one of the second grounding slots 481. The pair of first grounding slots 421 are centrosymmetric with the pair of second grounding slots 481. That is to say, the grounding connector 45 is disposed on a center of the pair of first grounding slots 421 and the pair of second grounding slots 481.

Referring to FIG. 3, the coupling portion 60 has the same shape with the grounding portion 40 and is corresponding to the third radiator 26 and the fourth radiator 28. The coupling portion 60 and the grounding portion 40 are symmetrically positioned on the second surface 202. The coupling portion 60 comprises a first coupling area 62, a second coupling area 68 and a coupling connector 65 communicationally connecting the first coupling area 62 with the second coupling area 68. The first coupling area 62 defines a pair of first coupling slots 621 and the second coupling area 68 defines a pair of second coupling slots 681. The pair of first coupling slots 621 are parallel to each other so that the first coupling area 62 is in an E-shape. Similarly, the pair of second coupling slots 681 are parallel to each other so that the second coupling area 68 is in an E-shape which is reverse to the first coupling area 62. In the illustrated embodiment, each of the pair of first coupling slots 621 is collinear with and communicates with a corresponding one of the second coupling slots 681. The pair of first coupling slots 621 are centrosymmetric with the pair of second coupling slots 681. That is to say, the coupling connector 65 is disposed on a center of the pair of first coupling slots 621 and the pair of second coupling slots 681.

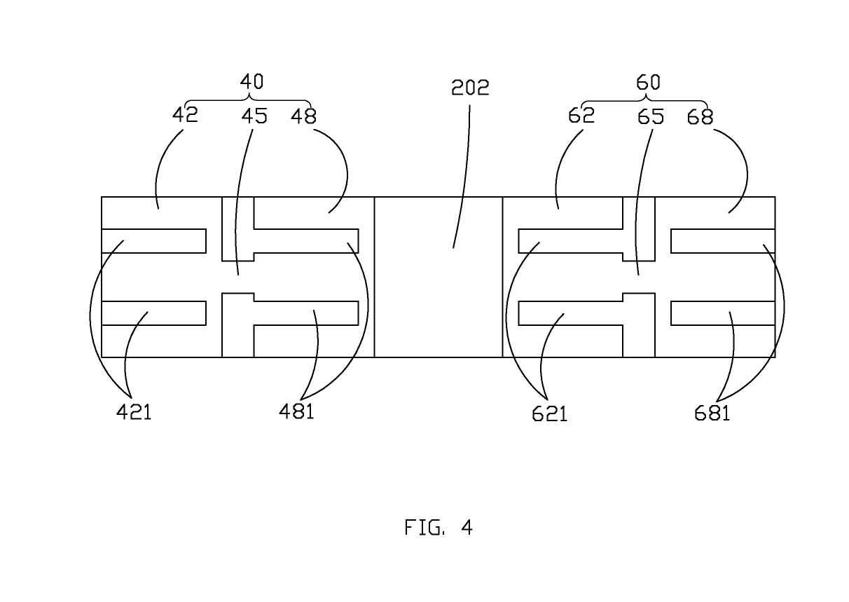

FIG. 4 is a schematic diagram showing the grounding portion 40 and the coupling portion 60 positioned on the second surface 202 of the substrate 200 according to a second preferred embodiment of the present disclosure. The first grounding area 42 and the second grounding area 48 are similar to those of FIG. 3, as well as the first coupling area 62 and the second coupling area 68 are similar to those of FIG. 3, except that each of the pair of first grounding slots 421 is collinear with and spaced from the corresponding second grounding slot 481 and each of the pair of first coupling slots 621 is collinear with and spaced from the corresponding second coupling slot 681. In the illustrated embodiment, the E-shape of the first grounding area 42 faces to the same direction to that of the second grounding area 48, and the E-shape of the first coupling area 62 faces to the same direction to that of the second coupling area 68. However, the E-shaped metal microstrips of the grounding portion 40 are reverse to the E-shaped metal microstrips of the coupling portion 60.

The E-shapes of the grounding portion 40 widen frequency bands for the monopole antenna 100. Moreover, the E-shape of the coupling portion 60 increase gains of the monopole antenna 100. By doing this, the performance of the monopole antenna 100 is optimized.

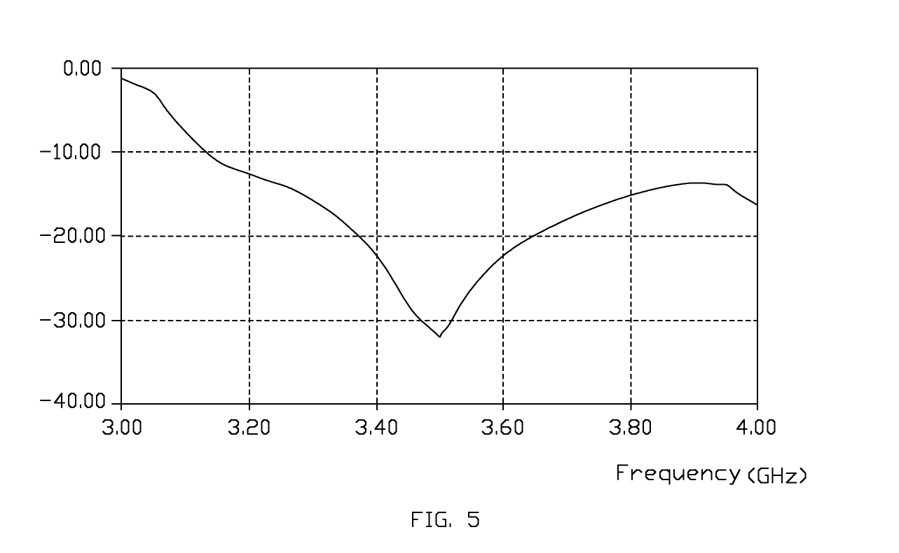

Referring to FIG. 5, an exemplary return loss of the monopole antenna 100 of FIG. 3 is shown. When the monopole antenna 100 operates in the frequency bands from 3.20 GHz to 3.80 GHz, the return loss is less than about −10 dB, which complies with the WIFI standards.

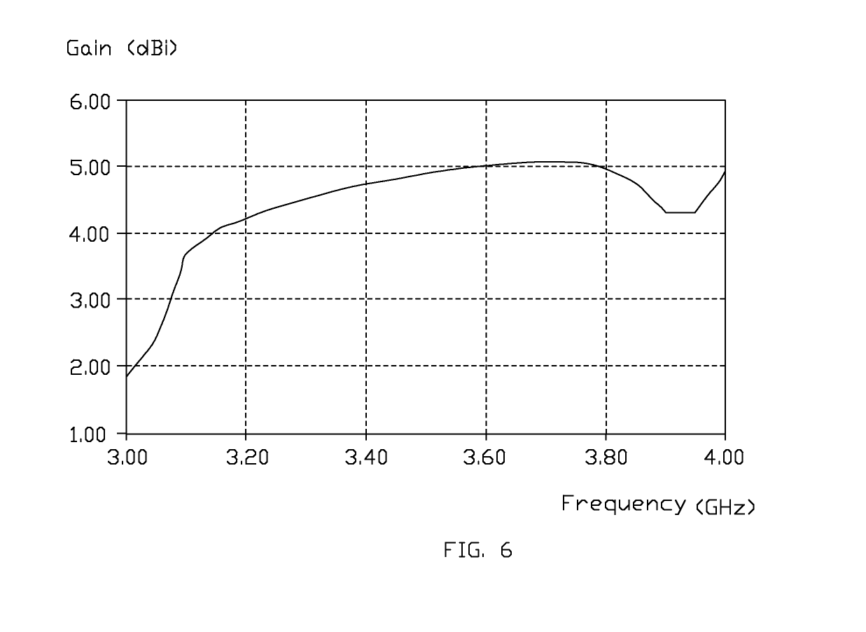

Referring to FIG. 6, an exemplary gain of the monopole antenna 100 of FIG. 3 is shown. When the monopole antenna 100 operates in the frequency bands from 3.20 GHz to 3.80 GHz, the gains is more than about 4 dBi. Moreover, changes of the gains are smooth.

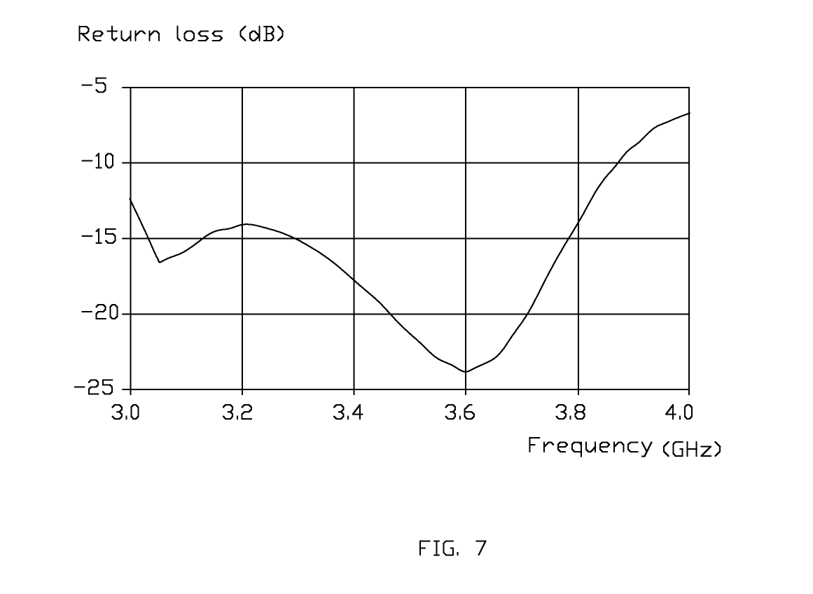

Referring to FIG. 7, an exemplary return loss of the monopole antenna 100 of FIG. 4 is shown. When the monopole antenna 100 operates in the frequency bands from 3.20 GHz to 3.80 GHz, the return loss is less than about −10 dB, which complies with the WIFI standards.

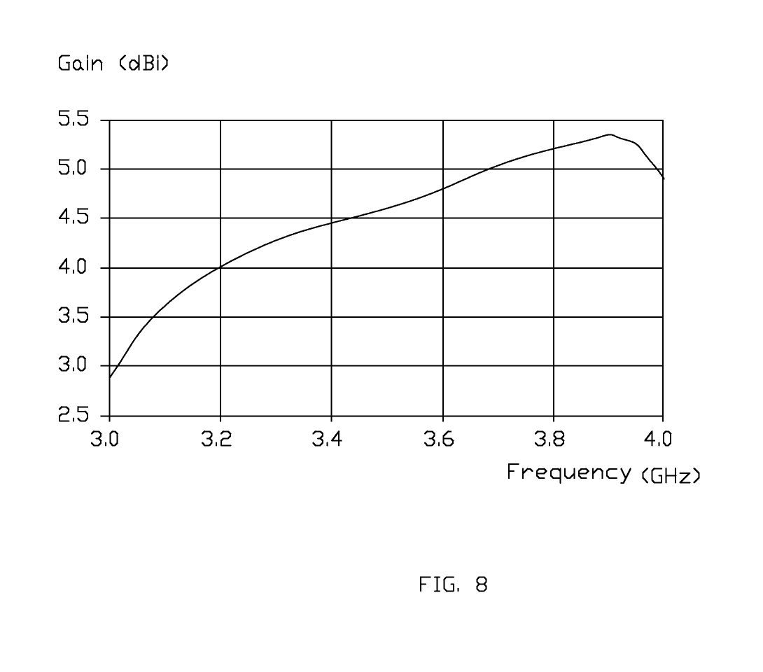

Referring to FIG. 8, an exemplary gain of the monopole antenna 100 of FIG. 4 is shown. When the monopole antenna 100 operates in the frequency bands from 3.20 GHz to 3.80 GHz, the gains is more than about 4 dBi. Moreover, changes of the gains are smooth.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A monopole antenna, disposed on a substrate comprising a first surface and a second surface opposite to the first surface, the monopole antenna comprising:
a feeding portion, disposed on the first surface to feed electromagnetic signals;
a radiating portion, disposed on the first surface and with one end connected to the feeding portion;
a grounding portion, positioned on the second surface substantially corresponding to the one end of the radiating portion connected to the feeding portion, the grounding portion comprising a first grounding area, a second grounding area, and a grounding connector communicationally connecting the first grounding area with the second grounding area, wherein the first grounding area and the second grounding area are both E-shaped metal microstrips; and
a coupling portion, disposed on the second surface and corresponding to the other end of the radiating portion.

2. The monopole antenna as claimed in claim 1, wherein the coupling portion comprises a first coupling area, a second coupling area and a coupling connector communicationally connecting the first coupling area with the second coupling area, the first coupling area and the second coupling area are both E-shaped metal microstrips.

3. The monopole antenna as claimed in claim 2, wherein the first grounding area defines a pair of first grounding slots and the second grounding area defines a pair of second grounding slots.

4. The monopole antenna as claimed in claim 3, wherein the first coupling area defines a pair of first coupling slots and the second coupling area defines a pair of second coupling slots, the pair of first coupling slots are parallel to each other so that the first coupling area is in an E-shape, the pair of second coupling slots are parallel to each other so that the second coupling area is in an E-shape.

5. The monopole antenna as claimed in claim 4, wherein each of the pair of first grounding slots is collinear with and communicates with a corresponding one of the second grounding slots , the E-shape of the first grounding area is reverse to that of the second grounding area.

6. The monopole antenna as claimed in claim 5, wherein each of the pair of first coupling slots is collinear with and communicates with a corresponding one of the second coupling slots, the E-shape of the first coupling area is reverse to that of the second coupling area.

7. The monopole antenna as claimed in claim 4, wherein each of the pair of first grounding slots is collinear with and spaced from the corresponding second grounding slot, the E-shape of the first grounding area faces to the same direction to that of the second grounding area, each of the pair of first coupling slots is collinear with and spaced from the corresponding second coupling slot, the E-shape of the first coupling area faces to the same direction to that of the second coupling area.

8. The monopole antenna as claimed in claim 7, wherein the E-shapes of the grounding portion are reverse to the E-shapes of the coupling portion.

9. The monopole antenna as claimed in claim 1, wherein the radiating portion comprises a first radiator, a second radiator, a third radiator and a fourth radiator, which are connected one by one, one end of the first radiator is connected with the feeding portion, and the first radiator and the third radiator are configured as slender microstrips.

10. The monopole antenna as claimed in claim 9, wherein the second radiator is disposed at a center of the radiating portion and configured as a rectangle microstrip, the second radiator is wider than the first radiator and the third radiator.

11. The monopole antenna as claimed in claim 10, wherein the third radiator is disposed between the second radiator and the fourth radiator, the fourth radiator extends from one end of the third radiator and shaped as a triangular metal layer.

12. The monopole antenna as claimed in claim 11, wherein the grounding portion is corresponding to the first radiator, the coupling portion is corresponding to the third radiator and the fourth radiator.
